(19) United States
(12) Patent Application Publication
(10) Pub. No.: US 2024/0417331 A1
(43) Pub. Date: Dec. 19, 2024

(54) ZIRCONIA SINTERED BODY AND METHOD FOR PRODUCING SAME

(71) Applicant: KCM Corporation, Nagoya-shi, Aichi (JP)

(72) Inventor: Akira KAWAI, Nagoya-shi (JP)

(73) Assignee: KCM Corporation, Nagoya-shi, Aichi (JP)

(21) Appl. No.: 18/708,652

(22) PCT Filed: Dec. 15, 2022
(86) PCT No.: PCT/JP2022/046221

§ 371 Date: May 9, 2024

(30) Foreign Application Priority Data
Dec. 20, 2021 (JP) 2021-206405
Sep. 7, 2022 (JP) 2022-142199

(51) Int. Cl. C04B 35/48; A61C 13/083; C04B 35/64

(52) U.S. Cl. CPC C04B 35/48; A61C 13/083; C04B 35/64; C04B 2235/3217; C04B 2235/3225; C04B 2235/3246; C04B 2235/656; C04B 2235/663; C04B 2235/667

(57) ABSTRACT

The present disclosure provides a method for producing a zirconia sintered body having an excellent strength and excellent translucency. A method for producing a zirconia sintered body that has been disclosed herein includes the following steps: a compact preparation step of preparing a compact containing zirconia and yttria and/or ytterbia, in which a proportion of the yttria and/or ytterbia is 3 mol % or more and 4.4 mol % or less when the zirconia and the yttria and/or ytterbia is set to 100 mol %, a first heating step of heating the compact at 800° C. or higher and 1200° C. or lower to obtain a calcined body, and a second heating step of heating the calcined body at 1600° C. or higher and 2000° C. or lower by microwave heating to obtain a zirconia sintered body.

### TECHNICAL FIELD

The present invention relates to a zirconia sintered body and a method for producing the same. The present application claims priority based on Japanese Patent Application No. 2021-206405, filed Dec. 20, 2021, and Japanese Patent Application No. 2022-142199, filed Sep. 7, 2022, the contents of which are incorporated herein by reference.

### BACKGROUND ART

Zirconia sintered bodies in which a solid solution of a small amount of yttria (Y₂O₃) has been formed (hereinafter, also referred to as “partially stabilized zirconia sintered bodies” in some cases) are in wide use as biomaterials such as dental restorative materials (for example, dentures and dental prosthetics) due to their high strength, toughness and aesthetics. For example, Patent Literature 1 discloses a translucent zirconia sintered body containing more than 4.0 mol % and 6.5 mol % or less of yttria and less than 0.1 wt % of alumina. This zirconia sintered body has a high sintered body density and excellent translucency and is thus considered to have both translucency and strength particularly suitable for dentures for front teeth.

In addition, Patent Literature 2 discloses a translucent zirconia sintered body composed of zirconia containing 2 to 4 mol % of yttria as a stabilizer and less than 0.1 wt % of alumina as an additive, in which the relative density is 99.8% or higher, the total light transmittance with a thickness of 1.0 mm is 35% or higher, and the crystal grain diameters are 0.20 to 0.45 μm. This zirconia sintered body has a high sintered body density and a high strength and is excellent in terms of translucent impression and is thus considered as an excellent sintered body that is used as, for example, milling blanks for denture materials or orthodontic brackets.

In addition, for example, Patent Literature 3 discloses a translucent zirconia sintered body containing 2.5 to 3.5 mol % of yttria and 0.05 to 0.3 weight % of alumina, in which the tetragonal rate is 90 weight % or more and the light transmittance at a wavelength of 600 nm with a specimen thickness of 1.0 mm is 30% or higher. This zirconia sintered body has excellent strength and toughness and is thus considered to be excellent in terms of, furthermore, hydrothermal degradation resistance.

### CITATION LIST

### Patent Literature

Patent Literature 1: Japanese Unexamined Patent Application Publication No. 2015-143178
Patent Literature 2: Japanese Unexamined Patent Application Publication No. 2014-185078
Patent Literature 3: Japanese Unexamined Patent Application Publication No. 2014-012627

### SUMMARY OF INVENTION

Incidentally, in a case where zirconia sintered bodies are used as dental restorative materials, required characteristics may vary depending on the type of a tooth that is to be restored. For example, a predetermined or higher strength and excellent translucency are required for dentures for front teeth, and on the other hand, an excellent strength and predetermined or higher translucency may be required for dentures for back teeth (molar dentures). Therefore, zirconia sintered bodies that are used as dental restorative materials are desirably excellent in terms of both strength and translucency.

Therefore, the present invention has been made in consideration of the above-described circumstance, and a main objective of the present invention is to provide a zirconia sintered body having an excellent strength and excellent translucency. In addition, another objective of the present invention is to provide a production method that realizes such a zirconia sintered body. Furthermore, still another objective of the present invention is to provide a dental restorative material including such a zirconia sintered body.

In order to realize the above-described objective, the present inventors performed studies and consequently found that a zirconia sintered body having an excellent strength and having superior translucency to the translucency of the translucent zirconia sintered bodies disclosed in Patent Literature 1 to 3 can be obtained by sintering a calcined body of partially stabilized zirconia having a predetermined yttria and/or ytterbia (Yb₂O₃) concentration by microwave heating at a temperature of 1600° C. or higher.

That is, one aspect of a method for producing a zirconia sintered body that is to be disclosed herein includes the following steps:
a compact preparation step of preparing a compact containing zirconia and yttria and/or ytterbia, in which a proportion of the yttria and/or ytterbia is 3 mol % or more and 4.4 mol % or less when a total of the zirconia and the yttria and/or ytterbia is set to 100 mol %, a first heating step of heating the compact at 800° C. or higher and 1200° C. or lower to obtain a calcined body, and a second heating step of heating the calcined body at 1600° C. or higher and 2000° C. or lower by microwave heating to obtain a zirconia sintered body. According to such a production method, a zirconia sintered body having an excellent strength and excellent translucency can be produced.

In one preferable aspect of the method for producing a zirconia sintered body that is to be disclosed herein, a heating method of the microwave heating is multimode. This makes it possible to heat the calcined body while suppressing the generation of plasma. As a result, the occurrence of cracking in the zirconia sintered body is suppressed, and a zirconia sintered body having an excellent strength and excellent translucency can be produced.

In one preferable aspect of the method for producing a zirconia sintered body that is to be disclosed herein, the microwave heating is performed in an oxidative atmosphere. This makes it possible to suppress the zirconia sintered body getting dark, and a zirconia sintered body having an excellent strength and excellent translucency and also having excellent aesthetics can be thus produced.

In addition, in one preferable aspect of the method for producing a zirconia sintered body that is to be disclosed herein, the microwave heating is performed in an atmosphere where an oxygen concentration is 30 vol % or higher and 100 vol % or lower. This makes it possible to effectively suppress the zirconia sintered body getting dark, and a zirconia sintered body having superior aesthetics and having an excellent strength and excellent translucency can be thus produced.

In addition, in one preferable aspect of the method for producing a zirconia sintered body that is to be disclosed herein, in the second heating step, SiC susceptors are disposed so as to sandwich the calcined body from both sides in a predetermined direction. This makes it possible to more suitably advance the sintering of the inside of the calcined body, and a zirconia sintered body that is superior in terms of strength and translucency can be thus produced.

In addition, in one preferable aspect of the method for producing a zirconia sintered body that is to be disclosed herein, the zirconia may contain a granular particle. When a granular particle is contained, the shape stability of the compact improves, and workability and handleability can improve.

In addition, the present disclosure provides a zirconia sintered body. This zirconia sintered body can be produced by any of the above-described production methods. A zirconia sintered body that is to be disclosed herein contains zirconia and yttria and/or ytterbia, in which a proportion of the yttria and/or ytterbia is 3 mol % or more and 4.4 mol % or less when a total of the zirconia and the yttria and/or ytterbia is set to 100 mol %. In addition, in this zirconia sintered body, a biaxial bending strength that is measured according to JIS T 6526 is 800 MPa or higher, and a total light transmittance with respect to a D65 light source in a thickness direction of a 1 mm-thick test piece is 44.5% or higher. This zirconia sintered body realizes excellent strength and excellent translucency.

One preferable aspect of the zirconia sintered body that is to be disclosed herein further contains alumina, in which a proportion of the alumina is 0.15 mass % or less when the entire zirconia sintered body is set to 100 mass %. This suppresses abnormal grain growth during zirconia sintering, and a decrease in the strength can be suppressed.

In addition, the present disclosure provides a dental restorative material containing the zirconia sintered body that is to be disclosed herein. The zirconia sintered body that is to be disclosed herein has an excellent strength and excellent translucency and thus can be suitably used as a dental restorative material.

### BRIEF DESCRIPTION OF DRAWINGS

FIG. 1 is a flowchart showing the outline of one embodiment of a method for producing a zirconia sintered body.

FIG. 2 is a schematic view showing one example of a method for the microwave heating of a calcined body.

### DESCRIPTION OF EMBODIMENTS

Hereinafter, a preferable embodiment of a technique that is to be disclosed herein will be described. A matter that is not a matter particularly described in the present specification (for example, the temperature of microwave heating) and is required to carry out the present invention can be understood based on technical contents that are taught by the present specification and general technical common senses in the related art. The contents of the technique that is to be disclosed herein can be carried out based on the contents that is to be disclosed in the present specification and technical common senses in the related art. An expression “A to B” (A and B are arbitrary numerical values) that indicates a range in the present specification means A or more and B or less and includes a range that is above A and below B.

A zirconia sintered body that is to be disclosed herein contains at least zirconia (ZrO₂) and at least one of yttria (Y₂O₃) and/or ytterbia (Yb₂O₃). That is, the zirconia sintered body that is to be disclosed herein has an aspect where both yttria and ytterbia are contained, an aspect where yttria is contained, but ytterbia is not contained and an aspect where ytterbia is contained, but yttria is not contained. The zirconia sintered body contains zirconia as a main component. Here, “containing zirconia as a main component” means that, among compounds that configure the zirconia sintered body, the proportion of zirconia is largest. When the entire zirconia sintered body is set to 100 mol %, the proportion of zirconia may be, for example, 70 mass % or more, is preferably 80 mass % or more and more preferably 90 mass % or more and can be 95 mass % or more. When the proportion of zirconia is high, the strength and toughness of the zirconia sintered body improve.

Yttria and/or ytterbia that is contained in the zirconia sintered body is typically contained as a stabilizer and is contained as at least a part of partially stabilized zirconia that partially forms a solid solution in zirconia. Zirconia typically has any of monoclinic, tetragonal and cubic crystal phases, but partially stabilized zirconia has a high tetragonal proportion at room temperature, and thus the strength and the toughness improve. In addition, in partially stabilized zirconia, since a variation in crystal phase is suppressed, the translucency improves.

When the total of zirconia and yttria and/or ytterbia that are contained in the zirconia sintered body (in other words, the total of zirconia and the stabilizer) is set to 100 mol %, the proportion of yttria and/or ytterbia is 3 mol % or more and 4.4 mass % or less and can be, for example, 3 mol % or more and 4.2 mol % or less, 3.5 mol % or more and 4.2 mol % or less or 3.5 mol % or more and 4 mol % or less. With such a proportion, the balance of the zirconia crystal phase is suitably adjusted, and an excellent strength and excellent translucency can be both satisfied. In addition, the proportion of yttria and/or ytterbia can be 3 mol % or more 3.5 mol % or less or 3 mol % or more or less than 3.5 mol %. Within such a range, the translucency generally becomes low, but excellent translucency can be realized in the zirconia sintered body that is to be disclosed herein.

Yttria and/or ytterbia may all form a solid solution in zirconia or may include yttria and/or ytterbia in a non-solid solution state, which does not form any solid solutions in zirconia.

The zirconia sintered body can further contain alumina (Al₂O₃). In the zirconia sintered body containing alumina, since abnormal grain growth is suppressed, it is possible to improve the strength and translucency of the zirconia sintered body. In addition, since the low-temperature deterioration resistance improves, it is possible to maintain the strength and translucency of the zirconia sintered body over a long period of time. Incidentally, alumina remains in the sintered body as an impurity and acts as a light scattering factor, and the alumina content is preferably not too high. Therefore, the content of alumina needs to be, for example, 0.15 mass % or less, is preferably 0.125 mass % or less and can be, for example, 0.1 mass % or less or 0.05 mass % or less when the entire zirconia sintered body is set to 100 mass %.

In addition, the zirconia sintered body may contain a conventionally well-known colorant to an extent that the strength and the translucency are not significantly impaired. Examples of the colorant include transition metal elements, lanthanide rare earth elements and the like. Examples of such elements include iron, nickel, cobalt, manganese, niobium, praseodymium, neodymium, europium, gadolinium, erbium and the like. The amount of the colorant needs to be, for example, 2 mass % or less of the entire zirconia sintered body and can be 1 mass % or less or 0.5 mass % or less.

In addition, the zirconia sintered body may contain an element that can be inevitably incorporated. Examples thereof include hafnium, magnesium, silicon, titanium and the like. The total content of these elements is preferably 2.5 mass % or less, more preferably 2 mass % or less and preferably, for example, 1.8 mass % or less in terms of the oxide.

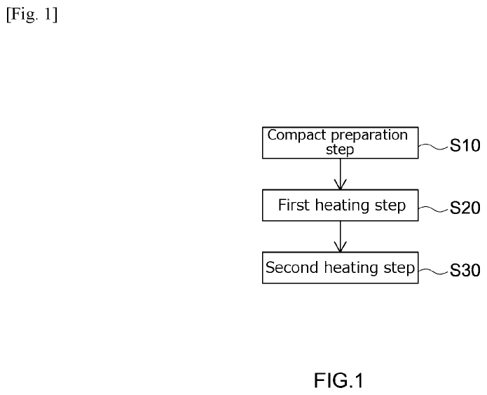

FIG. 1 is a flowchart showing the outline of a method for producing a zirconia sintered body. The method for producing a zirconia sintered body that is to be disclosed herein can include a compact preparation step S10 of preparing a compact containing zirconia and yttria and/or ytterbia, a first heating step S20 of heating the compact to obtain a calcined body, and a second heating step S30 of heating the calcined body by microwave heating to obtain a zirconia sintered body.

### <Compact Preparation Step S10>

The compact preparation step S10 can include the preparation of a material that configures a compact (hereinafter, also referred to as “compact material”) (hereinafter, also referred to as “compact material preparation step”) and the forming of the compact material (hereinafter, also referred to as “forming step”).

In the compact material preparation step, first, a zirconia raw material is prepared. The zirconia raw material is not particularly limited, and, for example, a zirconia salt or a hydrate thereof can be used. Examples of the zirconia salt include zirconium oxychloride, zirconium chloride, zirconium sulfate, zirconium nitrate and the like. These may be used singly or two or more thereof may be jointly used.

Next, an aqueous solution of the zirconia raw material is prepared, and a hydrolysis reaction is performed, thereby preparing a zirconia sol. The hydrolysis reaction can be performed by adding an alkali metal hydroxide, an alkaline earth metal hydroxide, an ammonia aqueous solution or the like to such an aqueous solution. As the alkali metal hydroxide, for example, lithium hydroxide, sodium hydroxide, potassium hydroxide or the like can be used, and, as the alkaline earth metal hydroxide, for example, magnesium hydroxide, calcium hydroxide or the like can be used.

Next, yttria and/or ytterbia or a raw material thereof is added to (or mixed with) the zirconia sol obtained by the hydrolysis (ZrO₂·nH₂O). The raw material of yttria is an yttria-containing compound that can turn into yttria by firing. As the yttria-containing compound, yttria chloride, yttria nitrate and the like are exemplified. The raw material of ytterbia may be an ytterbia-containing compound that can turn into ytterbia by firing. As the ytterbia-containing compound, ytterbia chloride, ytterbia nitrate and the like are exemplified.

In the case of adding yttria and/or ytterbia to the zirconia sol, the proportion of yttria and/or ytterbia to be added is the same as the proportion of yttria and/or ytterbia in the above-described zirconia sintered body, and, when the total of zirconia that is contained in the zirconia sol and yttria and/or ytterbia to be added is set to 100 mol %, the proportion of yttria and/or ytterbia to be added is 3 mol % or more and 4.4 mol % or less, and yttria and/or ytterbia is preferably added so that the proportion thereof reaches, for example, 3 mol % or more and 4.2 mol % or less, 3.5 mol % or more and 4.2 mol % or less or 3.5 mol % or more and 4 mol % or less. In addition, the proportion of yttria and/or ytterbia can be 3 mol % or more and 3.5 mol % or less or 3 mol % or more and less than 3.5 mol %. The above-described proportion of yttria and/or ytterbia can be the proportion of yttria and/or ytterbia in a compact, which will be described below.

In addition, in the case of mixing the yttria raw material and/or the ytterbia raw material into the zirconia sol, the amount of yttria and/or ytterbia that can be obtained by firing these raw materials needs to be within the above-described range of the proportion of yttria and/or ytterbia. For example, in the case of using X mol (X is a positive number) of yttrium chloride (YCl₃) as the yttria raw material, 0.5× mol of yttria (Y₂O₃) can be obtained, yttrium chloride needs to be mixed as much as the amount of the substance doubles compared with a case where yttria itself is mixed.

Next, the zirconia sol to which the yttria and/or ytterbia or a raw material thereof has been added is dried, whereby it is possible to obtain a dry powder in which each raw material has been homogeneously dispersed. A drying method is not particularly limited, and, for example, natural drying, blast drying, hot air drying, drying by heating using a heating furnace or the like, vacuum drying, suction drying, freeze drying or the like can be appropriately selected.

The powder obtained by drying is calcined, whereby a calcined powder containing yttria and/or ytterbia partially stabilized zirconia can be obtained. The calcination temperature is not particularly limited, but can be set to 800° C. to 1200° C., preferably 1000° C. to 1200° C. Due to such calcination, the yttria raw material can be oxidized into yttria, and the ytterbia raw material can be oxidized into ytterbia. As a heating device for the calcination, a conventionally well-known heating device can be used, and examples of the heating device include an electric furnace, a muffle furnace, a tunnel-type heating furnace, a microwave firing furnace and the like.

A calcined powder contains particles having a variety of shapes and particle diameters and is thus preferably crushed. A crushing method is not particularly limited, and the calcined powder can be crushed with, for example, a well-known crushing device (for example, a ball mill or the like). In the ball mill, zirconia balls having a diameter of approximately 0.1 mm to 5 mm are preferably used.

In addition, the crushed powder is preferably sorted into a desired particle diameter. For example, a zirconia powder having a desired particle diameter can be obtained with a mesh sieve, and the size of the mesh opening may be selected as appropriate in accordance with a desired particle diameter.

The average particle diameter of the zirconia powder that is used as the compact material is, for example, preferably 100 nm to 300 nm and more preferably 150 nm to 200 nm. When the average particle diameter is within such a range, the sinterability is high, and the strength and the translucency can improve. In the present specification, “average particle diameter” refers to a particle diameter (D₅₀) corresponding to the cumulative frequency of 50% from the fine particle side in a volume-based particle size distribution measured by the laser diffraction scattering method. In such measurement, for example, a particle size analyzer LA950V2 (manufactured by Horiba, Ltd.) can be used.

The zirconia powder produced as described above mainly contains yttria and/or ytterbia partially stabilized zirconia particles. The proportion of the yttria and/or ytterbia partially stabilized zirconia particles in such a zirconia powder is 50 particle % or more and preferably 60 particle % or more and can be 70 particle % or more, 80 particle % or more, 90 particle % or more or 95 particle % or more. The zirconia powder may also contain fully stabilized zirconia. In addition, the zirconia powder may contain zirconia particles in which yttria and/or ytterbia does not form any solid solutions. Furthermore, the zirconia powder may contain yttria particles and/or ytterbia particles.

The zirconia powder as the compact material can be obtained as described above, but the compact material is not limited to such a zirconia powder.

For example, an aluminum compound may be mixed into the zirconia powder. The aluminum compound can be oxidized into alumina by heating in the first heating step S20 and/or the second heating step S30. Therefore, the amount of the aluminum compound mixed needs to be determined so that the amount thereof becomes the content of alumina in the zirconia sintered body with an assumption that all aluminum that is contained in the aluminum compound is oxidized into alumina. As the aluminum compound, an alumina powder, an alumina sol, hydrated alumina, aluminum hydroxide, aluminum chloride, aluminum nitrate, aluminum sulfate or the like can be used. A slurry may be produced by dispersing the zirconia powder and the aluminum compound in a solvent such as water. In a case where the slurry is produced, a zirconia powder in which the aluminum compound has been suitably dispersed can be obtained by drying the slurry.

The average particle diameter of the aluminum compound is preferably substantially the same as or smaller than that of the zirconia powder. While not particularly limited, the average particle diameter of the aluminum compound is, for example, preferably 300 nm or less and more preferably 200 nm or less and may be 150 nm or less or 100 nm or less (for example, 20 nm to 50 nm). In such a case, the aluminum compound is capable of suitably dispersing in the zirconia powder. Therefore, it is possible to more uniformly disperse alumina in the zirconia sintered body and to suitably suppress abnormal grain growth in the zirconia sintered body.

In addition, the compact material can be suitably used even when having a granular shape instead of a powder shape. The average particle diameter of the granular compact material is, for example, 10 μm to 100 μm and can be 20 μm to 90 μm or 40 μm to 80 μm. When the compact material has a granular shape, the shape stability improves, and the handleability or the workability can improve. Additionally, residual stress during forming is relaxed, which makes it possible to suppress the generation of a hot spot attributed to a powder density difference during the microwave heating. In addition, in the production method that is disclosed herein, since the zirconia sintered body is obtained by heating with microwaves, it is possible to suitably heat even the insides of granules having a larger average particle diameter than the powder. As a result, a zirconia sintered body having an excellent strength and excellent translucency can be produced.

A method for producing a granular zirconia sintered body is not particularly limited, and the granular zirconia sintered body can be produced by, for example, the spray drying of the zirconia powder. Such a zirconia sintered body may contain an aluminum compound and may further contain a binder.

The binder is preferably a component that is burnt through at the heating temperature in the first heating step or the second heating step, which will be described below. Examples of the binder include acrylic resins, epoxy-based resins, phenolic resins, amine-based resins, alkyd-based resins, cellulose-based polymers and the like. Among these, an acrylic resin is preferably contained. When an acrylic resin is contained, adhesiveness between the zirconia powders is enhanced, and zirconia granules can be suitably produced. In addition, the shape stability of the compact is enhanced, and the compact can be stably maintained. Examples of the acrylic resin include polymers containing alkyl (meth)acrylate as a primary monomer (a component that occupies 50 mass % or more of all monomers) or copolymers containing such a primary monomer and a secondary monomer that can be copolymerized with the primary monomer. “(Meth)acrylate” in the present specification is a term having a meaning of acrylate and methacrylate.

In a case where the amount of the binder is too large, there are cases where voids are likely to be generated in the zirconia sintered body after the binder is burnt through. When voids are generated in the zirconia sintered body, the strength can decrease. In addition, voids make it easy for light to be refracted, and the translucency can deteriorate. Therefore, when the amount of the entire powder that is used in the spray drying is set to 100 mass %, the content of the binder needs to be, for example, 10 mass % or less and is preferably 5 mass % or less. In addition, when the amount of the binder is too small, the effect of the binder can become insufficient. Therefore, the content of the binder needs to be, for example, 0.5 mass % or more and can be 1 mass % or more.

Next, the forming step will be described. A method for forming the compact material is not particularly limited, and it is possible to employ, for example, pressure forming, injection forming, extrusion forming, casting forming or the like. As the pressure forming, for example, cold isostatic pressing (CIP), hot isostatic pressing (HIP) or the like is preferably employed. According to CIP or HIP, highly homogeneous compacts having a high density can be produced.

### <First Heating Step S20>

In the first heating step S20, the compact is heated, whereby the compact is calcined, and a calcined body is obtained. Such heating can remove components such as moisture, the binder, and an impurity that can be contained in the compact. In addition, the calcination can reduce voids that can be present in the compact, which makes it possible to prevent a crack that can be generated during sintering performed by heating at a higher temperature and a higher speed. The calcination can be performed at a heating temperature of, for example, 800° C. to 1200° C., preferably 1000° C. to 1100° C. The calcination time can vary with the shape, size, composition or the like of the compact and may thus be adjusted as appropriate, may be, for example, 1.5 hours to five hours and can be two hours to four hours. Heating for the calcination can be performed by a well-known method, and it is possible to use, for example, a heating device such as a muffle furnace, an electric furnace or a microwave firing furnace.

The temperature increase rate in the heating of the first heating step S20 is not particularly limited and can be set to, for example, 100° C./h to 250° C./h until 800° C. is reached and to 50° C./h to 150° C./h until a predetermined temperature (for example, 1000° C. to 1200° C.) is reached. In such a case, it is possible to prevent abrupt sintering and to suppress the generation of a crack.

### <Second Heating Step S30>

In the second heating step S30, the calcined body obtained in the first heating step S20 is sintered by microwave heating, and a zirconia sintered body is obtained. Since the microwave heating makes it possible to rapidly heat the inside of the calcined body, the difference between the progress of the sintering of the surface and the progress of the sintering of the inside of the calcined body becomes small, and it is possible to further reduce voids in the zirconia sintered body. Therefore, the strength and translucency of the zirconia sintered body can be improved. Hereinafter, an embodiment of the second heating step S30 will be described with reference to a drawing. A method for the microwave heating is not limited to the following example.

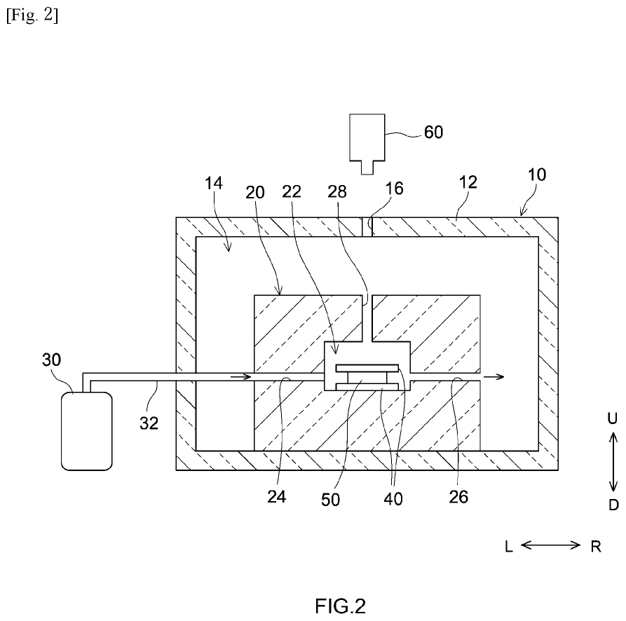

FIG. 2 is a schematic view showing one example of the method for the microwave heating of the calcined body. Dimensional relationships (length, width, thickness and the like) in FIG. 2 do not reflect actual dimensional relationships. Upward, downward, rightward and leftward are indicated by arrows U, D, R and L in the drawing, respectively. Here, upward, downward, rightward and leftward are designated only for the convenience of description and do not limit installation forms.

As shown in FIG. 2, a microwave heating device 10 has a partition 12 and a heating space 14. In the heating space 14, a heat-insulated container 20 is installed, susceptors 40 and a calcined body 50 are accommodated in an accommodation space 22 of the heat-insulated container 20. In addition, a gas supplying machine 30 is connected to the accommodation space 22 of the heat-insulated container 20. A radiation thermometer 60 is installed at a distant position outside the microwave heating device 10.

The microwave heating device 10 has the heating space 14 surrounded by the partition 12. The heating space 14 is a space that accommodates a microwave heating target. While not shown, the side walls, ceiling and bottom wall of the heating space 14 have microwave radiation portions and are capable of radiating microwaves to the target accommodated in the heating space 14 and heating the target. The microwaves need to have a frequency that has been used for conventional microwave heating, and, for example, microwaves having a frequency of 0.3 GHz to 3 GHz (for example, 2.45 GHz) can be used.

The partition 12 thermally insulates the heating space 14 of the microwave heating device 10 and the outside, and a commercially available microwave device can be used. In addition, the heating space 14 side of the partition 12 may be lined with a heat-insulating material from the viewpoint of enhancing the heat-insulating properties.

A through hole 16 for measuring the temperature of the target in the heating space 14 is provided in the partition 12. The through hole 16 penetrates the partition so as to connect the heating space 14 and the outside of the microwave heating device 10. In this embodiment, a transparent heat-resistant member (for example, fused quartz or the like) is mounted in the through hole 16, which makes it possible to seal the heating space 14 and measure the temperature of an article to be heated with the radiation thermometer 60.

As the microwave heating device 10 having such a configuration, for example, μ-Reactor EX or μ-Reactor Mx manufactured by Shikoku Instrumentation Co., Ltd. or the like can be used.

The heat-insulated container 20 has the accommodation space 22 where the susceptors 40 and the calcined body 50 can be accommodated. In addition, as shown in FIG. 2, in this embodiment, the heat-insulated container 20 has a gas introduction hole 24 for connecting the accommodation space 22 and the gas supplying machine 30, a gas exhaust hole 26 that makes the accommodation space 22 and the heating space 14 communicate with each other and a through hole 28 for measuring the temperature of the article to be heated in the accommodation space 22. In this embodiment, the heat-insulated container 20 is a rectangular parallelepiped box-type container, but the shape thereof is not particularly limited and may be, for example, a cylindrical shape, a prismatic shape or the like. In addition, while not shown, in this embodiment, the heat-insulated container 20 is designed to be separatable into a lid part and a case part and is designed to enable the article to be heated to be easily put into and out of the accommodation space 22. As a material of the heat-insulated container 20, for example, a ceramic fiber such as an alumina silica fiber can be employed.

The gas introduction hole 24 is a through hole that makes the accommodation space 22 and the heating space 14 communicate with each other and is designed so that a pump 32 connected with the gas supplying machine 30 can be inserted thereinto. Therefore, a desired gas can be supplied to the accommodation space 22, and the atmosphere in the accommodation space 22 can be controlled.

The gas exhaust hole 26 is a through hole that makes the accommodation space 22 and the heating space 14 communicate with each other and is designed so that the accommodation space 22 is not sealed. Therefore, a phenomenon in which oxygen in the accommodation space 22 is consumed in association with the progress of the firing of the calcined body 50 and the accommodation space 22 turns into a reducing atmosphere can be prevented. In addition, the gas exhaust hole 26 can prevent a gas that is supplied from the gas introduction hole 24 from remaining in the accommodation space 22. In FIG. 2, one gas exhaust hole 26 is provided, but a plurality of (two or more) gas exhaust holes may be provided. In addition, in this embodiment, the gas exhaust hole 26 is provided in a wall facing a wall provided with the gas introduction hole 24, but the position of the gas exhaust hole 26 is not particularly limited. The diameter of the gas exhaust hole 26 is not particularly limited and can be set to, for example, approximately 5 mm to 50 mm or, for example, approximately 5 mm to 20 mm.

As shown in FIG. 2, in this embodiment, the through hole 28 that makes the accommodation space 22 and the heating space 14 communicate with each other is provided on the upper side of the heat-insulated container 20. In addition, the through hole 28 is disposed so that the through hole 28 and the through hole 16 in the microwave heating device 10 are arranged on a straight line. This makes it possible to measure the temperature of the article to be heated disposed in the accommodation space 22 with the radiation thermometer 60 installed outside the microwave heating device 10. The through hole 28 needs to be provided in a size large enough for the radiation thermometer 60 to measure the temperature of the article to be heated, and the diameter of the through hole 28 can be thus set to approximately 5 mm to 10 mm while not particularly limited. In this embodiment, the gas exhaust hole 26 and the through hole 28 are each provided, but only one thereof may be provided in the configuration since the above-described functions of both the gas exhaust hole 26 and the through hole 28 can be exhibited by one through hole.

The gas supplying machine 30 is capable of supplying a desired gas to the accommodation space 22 in the heat-insulated container 20 through the pump 32 and adjusting the atmosphere of the accommodation space 22. The gas supplying machine 30 can be modified as appropriate depending on the desired gas, and a commercially available gas supplying machine (for example, an oxygen supplying machine) can be thus used with no particular limitations. In the case of adjusting the accommodation space 22 under the atmospheric atmosphere, a blower or the like may be employed as the gas supplying machine 30.

When the oxygen concentration around the calcined body 50 decreases in association with the firing of the calcined body 50, there are cases where zirconia that is contained in the calcined body 50 is reduced. Therefore, the zirconia sintered body can get dark, and the aesthetics can be impaired. Therefore, the microwave heating is preferably performed in an oxidative atmosphere. Examples of the oxidative atmosphere include the atmospheric atmosphere or an atmosphere in which the oxygen concentration is higher than that in the atmospheric atmosphere. Particularly, the oxygen concentration is preferably 30 vol % or higher and can be, for example, 50 vol % or higher or 70 vol % or higher. Under such an oxidative atmosphere, the zirconia sintered body getting dark can be further suppressed. The upper limit of the oxygen concentration in the atmosphere is not particularly limited, and the oxygen concentration can be set to 100 vol % or lower; however, when the oxygen concentration is too high, there are cases where abnormal heating caused by oxygen plasma occurs. Therefore, the oxygen concentration is, for example, preferably 95 vol % or lower and more preferably 90 vol % or lower. Such a control of the atmosphere to be oxidative may be performed in the accommodation space 22 in the heat-insulated container 20 where the calcined body 50 is installed.

In addition, since the atmosphere is controlled to be oxidative during the firing of the calcined body 50, it is preferable to continuously supply the atmosphere or a gas having the above-described oxygen concentration to the accommodation space 22 (the calcined body 50 in detail). This makes it possible to suppress a change in the atmosphere of the accommodation space 22 in association with the firing (for example, a decrease in the oxygen concentration or the like). In addition, as shown by the arrows in FIG. 2, a gas that is supplied from the gas supplying machine 30 flows into the accommodation space 22 and then exhausted from the gas exhaust hole 26 and/or the through hole 28. When such an oxygen flow environment is formed around the calcined body 50, it is possible to suppress the occurrence of abnormal heating caused by oxygen plasma.

The susceptor 40 is a heating auxiliary member capable of increasing the efficiency of the microwave heating by efficiently converting the energy of microwaves into a thermal energy. Specifically, the susceptor 40 absorbs microwaves, thereby rapidly reaches a higher temperature than the calcined body 50 and is thus capable of assisting an increase in the temperature of the calcined body 50 by thermal conduction. When the calcined body 50 reaches a high temperature, the calcined body 50 itself gets to easily absorb microwaves and is capable of behaving as a microwave absorber. When the calcined body 50 gets to easily absorb microwaves, the internal heating mechanism of the calcined body 50 becomes easy to be accelerated by the microwave heating. Therefore, the sintering of the inside of the calcined body 50 is accelerated, voids are difficult to remain in the calcined body, and a zirconia sintered body having an excellent strength and excellent translucency can be produced.

From the viewpoint of increasing the temperature of the calcined body 50 within a short period of time, the susceptors 40 are preferably disposed so as to sandwich the calcined body 50 from both sides in a predetermined direction. Examples thereof include aspects in which the susceptors 40 are disposed on both side (that is, on the upper side and the lower side) in the vertical direction (up and down direction) of the calcined body 50 or disposed on both sides in at least one direction in the horizontal direction of the calcined body 50 and the like. In such a case, since the surfaces of the calcined body 50 on both sides in a predetermined direction are heated with the susceptors 40, it is possible to increase the microwave absorption efficiency of the calcined body 50 within a shorter period of time. As a result, the internal heating of the calcined body 50 by the microwave heating can be realized within a short period of time, and it is thus possible to produce a zirconia sintered body having an excellent strength and excellent translucency in which internal voids have been further reduced. The susceptors 40 to be disposed are typically disposed so as to come into contact with the surfaces of the calcined body 50, but a gap may be present between the susceptor 40 and the surface of the calcined body 50. The size of such a gap is not particularly limited, but is, for example, preferably 3 mm or less, more preferably 2 mm or less and still more preferably 1 mm or less.

In addition, the calcined body 50 is preferably not sealed with the susceptors 40. This makes it easy for microwaves to be directly absorbed into the calcined body 50 without being impaired by the susceptor 40. Therefore, the internal heating of the calcined body can be induced from a low-temperature region compared with a case where the susceptors completely encapsulate the calcined body (for example, a case where the calcined body is installed in a closed box-type susceptor). As a result, pores that remain in the zirconia sintered body are reduced compared with those in a sintering aspect attributed to thermal conduction from surfaces, whereby a zirconia sintered body having a higher strength and higher translucency can be obtained. In addition, the calcined body 50 is not sealed with the susceptors 40, whereby it is possible to prevent the phenomenon in which oxygen around the calcined body 50 is consumed and the atmosphere turns into a reducing atmosphere.

In addition, it is preferable that no susceptors 40 are installed on both sides of the calcined body 50 in at least one direction that is different from the predetermined direction in which the susceptors 40 are disposed (the calcined body is open). This makes it easier for microwaves to be directly absorbed into the calcined body 50, and internal heating can be induced more homogeneously from a lower-temperature region. In addition, one direction in which no susceptors 40 are installed is provided, whereby the calcined body 50 can be disposed in the flow of the gas that is supplied from the gas supplying machine 30, and it is thus possible to more suitably control the atmosphere around the calcined body 50.

In this embodiment, as shown in FIG. 2, the calcined body 50 is sandwiched in the vertical direction by the two plate-shaped susceptors 40, and the calcined body 50 is not covered with the susceptors 40 in the horizontal direction. In such a configuration, since no susceptors 40 are disposed in any of the horizontal directions of the calcined body 50, particularly, it becomes easy for microwaves to be absorbed into the calcined body 50, and a zirconia sintered body having a superior strength and superior translucency is likely to be produced.

As the susceptor 40, a SiC susceptor containing silicon carbide (SiC) as a main component is preferably employed. Here, “containing SiC as a main component” refers to the fact that SiC occupies 50 mass % or more of a compound that configures the susceptor 40. Examples of the SiC susceptor include single crystal SiC, recrystallized SiC, reaction-sintered SiC, nitride-bonded SiC, oxide-bonded SiC, silicon carbide fibers and the like. In addition, among these, recrystallized SiC or a silicon carbide fiber, which is a material having a relatively high porosity, can be preferably used from the viewpoint of increasing the microwave absorption efficiency. In addition, between these, recrystallized SiC is excellent in terms of heat resistance, and it is thus possible to particularly preferably use recrystallized SiC. Furthermore, as recrystallized SiC, since there are cases where the microwave absorption efficiency decreases in dense recrystallized SiC, the porosity of recrystallized SiC needs to be, for example, 10% to 90% and is preferably 10% to 30%. The porosity can be measured by a conventionally well-known method and can be measured by, for example, the mercury intrusion method.

In a case where the susceptor 40 has a plate shape, the thickness of one susceptor is, for example, preferably 1 mm to 4 mm and more preferably 2 mm to 3 mm. When the susceptor 40 is too thin, the strength of the susceptor can decrease. In addition, when the susceptor 40 is too thick, the susceptor 40 is not easily heated, and the temperature increase rate becomes slow. Therefore, when the thickness is within the above-described range, the balance between both the strength of the susceptor 40 and the temperature increase rate of the susceptor 40 becomes suitable. Therefore, a zirconia sintered body that is more suitably excellent in terms of strength and translucency can be produced.

In the embodiment shown in FIG. 2, one plate-shaped susceptor 40 is disposed on each of the upper side and the lower side of the calcined body 50; however, in a case where a plurality of (two or more) plate-shaped susceptors 40 are provided, the number thereof is not particularly limited. For example, two or more susceptors 40 may be overlaid on each of the upper side and the lower side of the calcined body 50. In addition, the numbers of the susceptors 40 used on the upper side and the lower side of the calcined body 50 may be different.

In the present embodiment, the susceptor 40 has a plate shape, but the shape thereof is not particularly limited as long as the susceptors 40 are disposed on both sides in a predetermined direction of the calcined body 50. Examples thereof include box-type (for example, a hexahedral shape) susceptor having through holes on a pair of facing surfaces, a columnar susceptor (for example, a cylindrical or prismatic susceptor) and the like.

The radiation thermometer 60 is capable of measuring the temperature of a target in a non-contact manner. As shown in FIG. 2, in this embodiment, the radiation thermometer 60 is installed at a position distant from the microwave heating device 10 and measures the surface temperature of the susceptor 40 on the upper side of the calcined body 50. In the present specification, the heating temperature during the microwave heating in the second heating step S30 refers to a temperature measured with the radiation thermometer 60. The radiation thermometer 60 is preferably fixed to a predetermined position with a clamp or the like from the viewpoint of more accurately measuring temperature changes due to the microwave heating. As the radiation thermometer 60, for example, an OPTCTRF1MHSFVFC3 sensor (pseudo emissivity setting: 1.0) manufactured by Optris can be used.

The temperature of the microwave heating needs to be, for example, 1600° C. or higher (for example, higher than 1600° C.) and is preferably 1620° C. or higher, more preferably 1650° C. or higher, still more preferably 1700° C. or higher (for example, higher than 1700° C.) and particularly preferably 1720° C. or higher. The mechanism thereof is not particularly limited, but it is assumed that, when the temperature of the microwave heating is set to a high temperature of 1600° C. or higher, the proportion of tetragonal crystals increases in the crystal phase of the zirconia sintered body and the strength thus improves. In addition, a variation in the crystal phase reduces, whereby the discontinuity of crystal grain boundaries reduces. Therefore, it is assumed that light that passes through the zirconia sintered body is less likely to be reflected or refracted at the interfaces between the crystals and the translucency thus improves.

In addition, while not particularly limited, the temperature of the microwave heating is appropriately, for example, 2000° C. or lower from the viewpoint of the heat resistance or the like of the heating device and can be set to, for example, 1900° C. or lower, 1800° C. or lower, 1750° C. or lower or 1730° C. or lower. In one example, the temperature of the microwave heating is 1600° C. to 2000° C. and can be preferably 1620° C. to 1800° C. or 1650° C. to 1730° C. The holding time of the microwave heating is changed as appropriate depending on the shape, size, composition or the like of the calcined body 50 and can be set to, for example, approximately one minute to 20 minutes or, for example, approximately one minute to 10 minutes. The holding time mentioned herein does not include the time taken to increase the temperature up to the microwave heating temperature.

A heating method of the microwave heating is not particularly limited, for example, any of a single mode and a multimode can be used, but a multimode is preferably employed. In the single mode, there is a possibility that plasma may be generated in the calcined body 50 depending on the disposition position, size or the like of the calcined body 50, and there are cases where cracking occurs in the zirconia sintered body. On the other hand, in the multimode, the concentration of an electromagnetic field in the heating space 14 is suppressed, and plasma is thus less likely to be generated. Therefore, the occurrence of cracking in the zirconia sintered body is suppressed, and a zirconia sintered body having an excellent strength and excellent translucency is likely to be produced.

The temperature increase rate of the microwave heating is changed as appropriate depending on the shape, size, composition or the like of the calcined body and is thus not particularly limited, but is preferably set to, for example, 500° C./min to 900° C./min until approximately 1000° C. to 1100° C. is reached. This makes it possible to produce a zirconia sintered body within a shorter period of time. In addition, the temperature increase rate is preferably set to, for example, 20° C./min to 50° C./min until approximately 1100° C. to 1200° C. is reached. This makes it possible to reduce the generation of a crack due to abrupt sintering of zirconia. In addition, the temperature increase rate is preferably set to, for example, 40° C./min to 60° C./min until approximately 1600° C. to 2000° C. is reached. In such a case, the progress of the sintering of the calcined body is appropriately controlled, and a zirconia sintered body having a superior strength and superior translucency can be produced.

The shape of the calcined body 50 is not particularly limited, but is preferably, for example, a disc shape from the viewpoint of more uniformly performing sintering with microwaves. The thickness of the calcined body 50 is, for example, preferably 0.5 mm to 10 mm and more preferably 0.5 mm to 2 mm. Within such a range, it is possible to efficiently perform sintering with microwaves while holding the strength of the calcined body 50. In addition, the maximum diameter of the calcined body 50 is, for example, preferably 10 mm to 60 mm and more preferably 10 mm to 20 mm. Within such a range, it is possible to more uniformly perform sintering with microwaves.

The zirconia sintered body that is produced as described above realizes an excellent strength and excellent translucency. For example, the biaxial bending strength of such a zirconia sintered body can be 800 MPa or higher, preferably 850 MPa or higher, more preferably 900 MPa or higher and still more preferably 1000 MPa or higher (for example, 1200 MPa or higher). In addition, the upper limit of the biaxial bending strength is not particularly limited, but can be, for example, 1500 MPa or lower, 1300 MPa or lower, 1250 MPa or lower or the like. In the present specification, the biaxial bending strength refers to a strength measured according to JIS T 6526.

Regarding the translucency of the zirconia sintered body that has been disclosed herein, for example, the total light transmittance is 44.5% or higher, preferably 44.7% or higher, more preferably 45% or higher and still more preferably 46% or higher and, furthermore, can be 46.5% or higher. In addition, while not particularly limited, the total light transmittance can be, for example, 55% or lower or 51% or lower. In the present specification, “total light transmittance” refers to the total light transmittance with respect to a D65 light source in the thickness direction of a 1 mm-thick disc-shaped test piece.

The zirconia sintered body that has been disclosed herein has both an excellent strength and excellent translucency and can be thus suitably used as, for example, dental restorative materials such as dentures for front teeth, dentures for back teeth, dental prosthetics and bridges.

As described above, specific aspects of the technique that has been disclosed herein include what will be described in each of the following sections.

Section 1: A method for producing a zirconia sintered boy including the following steps:
a compact preparation step of preparing a compact containing zirconia and yttria and/or ytterbia, in which the proportion of the yttria and/or ytterbia is 3 mol % or more and 4.4 mol % or less when the total of the zirconia and the yttria and/or ytterbia is set to 100 mol %,
a first heating step of heating the compact at 800° C. or higher and 1200° C. or lower to obtain a calcined body, and
a second heating step of heating the calcined body at 1600° C. or higher and 2000° C. or lower by microwave heating to obtain a zirconia sintered body.

Section 2: The method for producing a zirconia sintered boy according to Section 1, in which a heating method of the microwave heating is multimode.

Section 3: The method for producing a zirconia sintered boy according to Section 1 or 2, in which the microwave heating is performed in an oxidative atmosphere.

Section 4: The method for producing a zirconia sintered boy according to Section 3, in which the microwave heating is performed in an atmosphere where the oxygen concentration is 30 vol % or higher and 100 vol % or lower.

Section 5: The method for producing a zirconia sintered boy according to any one of Sections 1 to 4, in which, in the second heating step, SiC susceptors are disposed so as to sandwich the calcined body from both sides in a predetermined direction.

Section 6: The method for producing a zirconia sintered boy according to any one of Sections 1 to 5, in which the zirconia contains a granular particle.

Section 7: A zirconia sintered body contains zirconia and yttria and/or ytterbia, in which the proportion of the yttria and/or ytterbia is 3 mol % or more and 4.4 mol % or less when the total of the zirconia and the yttria and/or ytterbia is set to 100 mol %,
here, the biaxial bending strength that is measured according to JIS T 6526 is 800 MPa or higher, and
the total light transmittance with respect to a D65 light source in the thickness direction of a 1 mm-thick test piece is 44.5% or higher.

Section 8: The zirconia sintered body according to Section 7 further containing alumina, in which the proportion of the alumina is 0.15 mass % or less when the entire zirconia sintered body is set to 100 mass %.

Section 9: A dental restorative material containing the zirconia sintered body according to Section 7 or 8.

In addition, one specific aspect that is included in the zirconia sintered body according to Section 6 is a zirconia sintered body containing zirconia and yttria and/or ytterbia, in which the proportion of the yttria and/or ytterbia is 3 mol % or more and 3.5 mol % or less (for example, 3 mol % or more and less than 3.5 mol %) when the total of the zirconia and the yttria and/or ytterbia is set to 100 mol %, herein, the biaxial bending strength that is measured according to JIS T 6526 is 800 MPa or higher, and the total light transmittance with respect to a D65 light source in the thickness direction of a 1 mm-thick test piece can be 44.5% or higher. Furthermore, the biaxial bending strength can be 900 MPa or higher or 1000 MPa or higher. According to a production method that is to be disclosed herein, even when proportion of yttria and/or ytterbia is 3.5 mol % or less, an excellent total light transmittance can be realized, and a zirconia sintered body can be provided with an excellent strength and excellent translucency.

Furthermore, one specific aspect that is included in the zirconia sintered body according to Section 6 is a zirconia sintered body containing zirconia and yttria and/or ytterbia, in which the proportion of the yttria and/or ytterbia is 3.5 mol % or more and 4.2 mol % or less when the total of the zirconia and the yttria and/or ytterbia is set to 100 mol %, herein, the biaxial bending strength that is measured according to JIS T 6526 is 800 MPa or higher, and the total light transmittance with respect to a D65 light source in the thickness direction of a 1 mm-thick test piece can be at least 46% or higher. According to the production method that is to be disclosed herein, in a zirconia sintered body in which the proportion of yttria and/or ytterbia is within the above-described range, excellent translucency can be realized, and a zirconia sintered body can be provided with an excellent strength and excellent translucency.

Hereinafter, examples relating to the technique that has been disclosed herein will be described, but such examples do not intend to limit the technique that has been disclosed herein.

### Example 1

Yttria was mixed with a zirconia sol generated by causing a hydrolysis reaction of a zirconium oxychloride solution. At this time, the amount of yttria was adjusted to be 3 mol % with respect to the total of zirconia and yttria. Such a mixture was dried and then calcined at 1200° C. for two hours, thereby obtaining a partially stabilized zirconia powder. Such a zirconia powder was crushed with a ball mill in which zirconia balls having a diameter of 1 mm were used and then sorted with a mesh sieve, thereby obtaining a zirconia powder having an average particle diameter of 150 nm to 200 nm as a compact material. A disc-shaped mold was filled with this zirconia powder, a pressure of 0.78 MPa was applied thereto, then, a compact was removed from the mold, and CIP forming was performed on such a compact at 196 MPa. After that, the obtained compact was heated at 1100° C. for two hours, thereby obtaining a calcined body. At this time, the temperature increase rate was set to 120° C./h up to 800° C. and to 100° C./h up to 1100° C.

The calcined body was accommodated in a heat-insulated container in a state where the calcined body was placed on a 2 mm-thick plate-shaped SiC susceptor and a 2 mm-thick plate-shaped SiC susceptor was placed on the calcined body. As the heat-insulated container, a container having the same configuration as the heat-insulated container 20 shown in FIG. 2 was used. In addition, a microwave heating device was installed in the heat-insulated container. For the SiC susceptors, recrystallized SiC was used. As the microwave heating device, μ-Reactor EX manufactured by Shikoku Instrumentation Co., Ltd. was used.

Next, a gas having an oxygen concentration of 90 vol % was supplied into the heat-insulated container using M1O2 silent (manufactured by Kobe Medicare Corporation) as a gas supplying machine. In addition, microwave heating was initiated while supplying the gas, and the temperature was increased at 600° C./min up to 1000° C., at 20° C./min up to 1100° C. and at 50° C./min up to 1730° C. and maintained at 1730° C. for one minute. After that, the microwave heating was stopped, and the calcined body was naturally cooled at room temperature. A zirconia sintered body of Example 1 was produced as described above. A multimode was used as a microwave heating method. In addition, OPTCTRF1MHSFVFC3 sensor manufactured by Optris was used for the measurement of the heating temperature, and the temperature of the SiC susceptor on the upper side of the calcined body was measured.

### Example 2

The yttria concentration was changed to 3.5 mol % from the production method of Example 1. In addition, the calcination conditions for obtaining a partially stabilized zirconia powder was changed to 1120° C. and four hours. Furthermore, an alumina powder having an average particle diameter of 30 nm was mixed into the partially stabilized zirconia powder such that the amount thereof reached 0.05 mass %. A zirconia sintered body of Example 2 was produced in the same manner as in Example 1 except what has been described above.

### Example 3

The yttria concentration was changed to 4.2 mol % from the production method of Example 1. In addition, the calcination conditions for obtaining a partially stabilized zirconia powder was changed to 1110° C. and four hours. Furthermore, the temperature increase rate for the microwave heating was changed to 900° C./min up to 1050° C. and to 40° C./min up to 1730° C. A zirconia sintered body of Example 3 was produced in the same manner as in Example 1 except what has been described above.

### Example 4

An alumina powder having an average particle diameter of 30 nm was mixed into the partially stabilized zirconia powder such that the amount thereof reached 0.05 mass % from the production method of Example 3. A zirconia sintered body of Example 4 was produced in the same manner as in Example 3 except what has been described above.

### Example 5

The yttria concentration was changed to 5.0 mol % from the production method of Example 1. In addition, the calcination conditions for obtaining a partially stabilized zirconia powder was changed to 1120° C. and four hours. Furthermore, an alumina powder having an average particle diameter of 30 nm was mixed into the partially stabilized zirconia powder such that the amount thereof reached 0.02 mass %. Additionally, the temperature increase rate for the microwave heating was changed to 900° C./min up to 1250° C., 5° C./min up to 1550° C. and to 40° C./min up to 1730° C. A zirconia sintered body of Example 5 was produced in the same manner as in Example 1 except what has been described above.

### Example 6

The yttria concentration was changed to 4.2 mol % from the production method of Example 1. In addition, the calcination conditions for obtaining a partially stabilized zirconia powder was changed to 1110° C. and four hours. Furthermore, an alumina powder having an average particle diameter of 30 nm was mixed into the partially stabilized zirconia powder such that the amount thereof reached 0.125 mass %, and furthermore, a polyacrylic binder was mixed thereinto as a binder such the amount thereof reached 3 mass %. In addition, such a mixture was made into granular shape by spray drying, thereby obtaining zirconia granules having an average particle diameter of 70 μm. Such zirconia granules were used as a compact material, a calcined body was obtained in the same manner as in Example 1, and the temperature increase rate for the microwave heating was then changed to 600° C./min up to 1150° C., 20° C./min up to 1200° C. and to 40° C./min up to 1730° C. A zirconia sintered body of Example 6 was produced in the same manner as in Example 1 except the above-described operations.

### Example 7

The yttria concentration was changed to 4.2 mol % from the production method of Example 1. In addition, the calcination conditions for obtaining a partially stabilized zirconia powder was changed to 1110° C. and four hours. Furthermore, the temperature increase rate for the microwave heating was changed to 900° C./min up to 1050° C. and 40° C./min up to 1650° C. and held at 1650° C. for three minutes. A zirconia sintered body of Example 7 was produced in the same manner as in Example 1 except what has been described above.

### Example 8

The yttria concentration was changed to 3.5 mol % from the production method of Example 1. In addition, the calcination conditions for obtaining a partially stabilized zirconia powder was changed to 1110° C. and four hours. Furthermore, the temperature increase rate for the microwave heating was changed to 500° C./min up to 1050° C. and 50° C./min up to 1620° C. and held at 1620° C. for one minute. A zirconia sintered body of Example 8 was produced in the same manner as in Example 1 except what has been described above.

### Example 9

Yttrium chloride and ytterbium chloride were mixed with a zirconia sol generated by causing a hydrolysis reaction of a zirconium oxychloride solution. Yttrium chloride and ytterbium chloride were mixed such that the amount of yttria reached 1.8 mol % and the amount of ytterbia reached 2.4 mol % with respect to the total of zirconia, yttria and ytterbia when yttrium chloride was converted into yttria and ytterbium chloride was converted into ytterbia. Such a mixture was dried and then calcined at 1120° C. for four hours, thereby obtaining a partially stabilized zirconia powder. Such a zirconia powder was crushed with a ball mill in which zirconia balls having a diameter of 1 mm were used and then sorted with a mesh sieve, thereby obtaining a zirconia powder having an average particle diameter of 150 nm to 200 nm as a compact material. An alumina powder having an average particle diameter of 30 nm was mixed into this powder such that the amount thereof reached 0.05 mass %. A disc-shaped mold was filled with this zirconia powder, a pressure of 0.78 MPa was applied thereto, then, a compact was removed from the mold, and CIP forming was performed on such a compact at 196 MPa. After that, the obtained compact was heated at 1100° C. for two hours, thereby obtaining a calcined body. At this time, the temperature increase rate was set to 120° C./h up to 800° C. and to 100° C./h up to 1100° C. After that, microwave heating was performed in the same manner as in Example 1, and a zirconia sintered body of Example 9 was obtained. Here, the microwave heating conditions were changed such that the temperature was increased at 900° C./min up to 1050° C. and at 40° C./min up to 1730° C. and maintained at 1730° C. for one minute.

### Example 10

A change was made to mix ytterbia chloride such that the ytterbia concentration reached 4.2 mol % from the production method of Example 9. No yttrium chloride was mixed with the zirconia sol. In addition, the calcination conditions for obtaining a partially stabilized zirconia powder was changed to 1100° C. and four hours. A zirconia sintered body of Example 10 was produced in the same manner as in Example 9 except what has been described above.

### Example 11

The ytterbia concentration was changed to 3.0 mol % from the production method of Example 10. In addition, the calcination conditions for obtaining a partially stabilized zirconia powder was changed to 1110° C. and four hours. In Example 11, no alumina powders were mixed with the zirconia sol. Furthermore, the temperature increase rate for the microwave heating was changed to 600° C./min up to 1100° C. and 50° C./min up to 1700° C. and held at 1700° C. for one minute. A zirconia sintered body of Example 11 was produced in the same manner as in Example 10 except what has been described above.

### <Evaluation of Translucency>

The zirconia sintered body produced in each example was processed into a 1 mm-thick disc-shaped test piece, both surfaces of the test piece were mirror-polished using a 0.5 μm diamond slurry as an abrasive, and the total light transmittance with respect to a D65 light source in the thickness direction was then measured. In such measurement, a haze meter NDH4000 manufactured by Nippon Denshoku Industries Co., Ltd. was used. The results are shown in Table 1.

### <Measurement of Biaxial Bending Strength>

The zirconia sintered body produced in each example was cut into a 1.2 mm-thick disc-shaped test piece, and the biaxial bending strength was then measured according to JIS T 6526. In such measurement, a table-top precision universal tester AUTOGRAPH AGS-5kNX manufactured by Shimadzu Corporation was used. The results are shown in Table 1

TABLE 1

| | Shape of | | | | Microwave | | Biaxial |
|---|---|---|---|---|---|---|---|
| | zirconia | Yttria | Ytterbia | Alumina | heating | Total light | bending |
| | before | proportion | proportion | content | temperature | transmittance | strength |
| | sintering | (mol %) | (mol %) | (mass %) | (° C.) | (%) | (MPa) |
| Example 1 | Powder | 3 | 0 | 0 | 1730 | 44.7 | 1030 |
| Example 2 | Powder | 3.5 | 0 | 0.05 | 1730 | 46.6 | 1250 |
| Example 3 | Powder | 4.2 | 0 | 0 | 1730 | 46.2 | 801 |
| Example 4 | Powder | 4.2 | 0 | 0.05 | 1730 | 48 | 870 |
| Example 5 | Powder | 5 | 0 | 0.02 | 1730 | 50.2 | 602 |
| Example 6 | Granule | 4.2 | 0 | 0.125 | 1730 | 47.2 | 806 |
| Example 7 | Powder | 4.2 | 0 | 0.05 | 1650 | 47.3 | 815 |
| Example 8 | Powder | 3.5 | 0 | 0.05 | 1620 | 46.6 | 1042 |
| Example 9 | Powder | 1.8 | 2.4 | 0.05 | 1730 | 48.5 | 862 |
| Example 10 | Powder | 0 | 4.2 | 0.05 | 1730 | 48 | 843 |
| Example 11 | Powder | 0 | 3 | 0 | 1700 | 44.8 | 1034 |

As shown in Table 1, it is found that, in all of Examples 1 to 11, the total light transmittance was 44.5% or higher (44.7% or higher in detail) and excellent translucency was realized. It is found that, in Examples 1 to 4 and 6 to 11 among them, the biaxial bending strengths were 800 MPa or higher and excellent strengths were realized. That is, it is found that, according to the production method that has been disclosed herein, it is possible to realize a zirconia sintered body having an excellent strength (biaxial bending strength: 800 MPa or higher) and excellent translucency (total light transmittance: 44.5% or higher).

Particularly, the results of Examples 1, 2, 8 and 11 show that not only excellent strengths (biaxial bending strengths: 800 MPa or higher) but also excellent translucency (total light transmittance: 44.5% or higher) are realized even in a case where the proportion of yttria and/or ytterbia is 3 mol % or more and 3.5 mol % or less. Generally, in sintered bodies of partially stabilized zirconia in which the proportion of yttria is relatively low (for example, 3.5 mol % or less) that have been sintered in a firing furnace or the like, the strength becomes high, but the total light transmittance becomes low, which means that there is a trade-off relationship therebetween. However, in the zirconia sintered body that has been disclosed herein, it is possible to increase the total light transmittance even in a case where the proportion of yttria and/or ytterbia is relatively low.

In addition, the results of Examples 2 to 4, 6 and 7 and 9 to 11 show that, even in a case where the proportion of yttria and/or ytterbia is 3.5 mol % or more and 4.2 mol % or less, not only excellent translucency (total light transmittance: 46% or higher) but also excellent strengths (biaxial bending strengths: 800 MPa or higher) are realized. Generally, in sintered bodies of partially stabilized zirconia in which the proportion of yttria is relatively high (for example, 3.5 mol % or more) that have been sintered in a firing furnace or the like, the translucency becomes high, but the strength becomes low, which means that there is a trade-off relationship therebetween. However, in the zirconia sintered body that has been disclosed herein, it is possible to realize an excellent strength even in a case where the proportion of yttria and/or ytterbia is relatively high. In addition, it is considered that the fact that a total light transmittance of 46% or higher is realized in the zirconia sintered body in which the proportion of yttria and/or ytterbia is 3.5 mol % or more and 4.2 mol % or less shows that the translucency is particularly excellent.

In addition, it is found from the comparison among Examples 3, 4 and 7 that the addition of alumina makes the translucency and the strength further improve.

In addition, as shown in Example 6, it is found that, even when a granular zirconia powder is used as the compact material, it is possible to realize a zirconia sintered body having excellent translucency and an excellent strength.

Hitherto, the specific examples of the technique that has been disclosed herein have been described in detail, but these are simply examples and do not limit the claims. In a technique to be described in the claims, a variety of transformations and modifications of the specific examples exemplified above are also included.

1. A method for producing a zirconia sintered body,
the method comprising the following steps:
a compact preparation step of preparing a compact containing zirconia and yttria and/or ytterbia, in which a proportion of the yttria and/or ytterbia is 3.5 mol % or more and 4.4 mol % or less when a total of the zirconia and the yttria and/or ytterbia is set to 100 mol %;
a first heating step of heating the compact at 800° C. or higher and 1200° C. or lower to obtain a calcined body; and
a second heating step of heating the calcined body at 1600° C. or higher and 2000° C. or lower by microwave heating to obtain a zirconia sintered body, wherein
the microwave heating is performed in an atmosphere where an oxygen concentration is 70 vol % or higher and 95 vol % or lower.

2. The method for producing a zirconia sintered body according to claim 1,
wherein a heating method of the microwave heating is multimode.

3. The method for producing a zirconia sintered body according to claim 1,
wherein the microwave heating is performed in an oxidative atmosphere.

4. (canceled)

5. The method for producing a zirconia sintered body according to claim 1,
wherein, in the second heating step, SiC susceptors are disposed so as to sandwich the calcined body from both sides in a predetermined direction.

6. The method for producing a zirconia sintered body according to claim 1,
wherein the zirconia contains a granular particle.

7. A zirconia sintered body comprising:
zirconia; and
yttria and/or ytterbia,
wherein a proportion of the yttria and/or ytterbia is 3.5 mol % or more and 4.4 mol % or less when a total of the zirconia and the yttria and/or ytterbia is set to 100 mol %,
here, a biaxial bending strength that is measured according to JIS T 6526 is 800 MPa or higher, and
a total light transmittance with respect to a D65 light source in a thickness direction of a 1 mm-thick test piece is 45% or more and 51% or less.

8. The zirconia sintered body according to claim 7, further comprising:
alumina,
wherein a proportion of the alumina is 0.15 mass % or less when the entire zirconia sintered body is set to 100 mass %.

9. A dental restorative material comprising:
the zirconia sintered body according to claim 7.
